(19) United States
(12) Patent Application Publication
(10) Pub. No.: US 2025/0100300 A1
(43) Pub. Date: Mar. 27, 2025

(54) IMAGE FORMING APPARATUS AND IMAGE FORMING SYSTEM

(71) Applicants: Ayane KUMAGAI, Tokyo (JP); Masaki KITAMURA, Kanagawa (JP); Ken ONODERA, Kanagawa (JP)

(72) Inventors: Ayane KUMAGAI, Tokyo (JP); Masaki KITAMURA, Kanagawa (JP); Ken ONODERA, Kanagawa (JP)

(73) Assignee: Ricoh Company, Ltd., Tokyo (JP)

(21) Appl. No.: 18/817,802

(22) Filed: Aug. 28, 2024

(30) Foreign Application Priority Data
Sep. 27, 2023 (JP) 2023-166132

(51) Int. Cl. B41J 11/00

(52) U.S. Cl. CPC B41J 11/00242; B41J 11/00222; B41J 11/0035; B41J 11/0045

(57) ABSTRACT

An image forming apparatus includes an image former to form an image on a sheet; a dryer to dry the sheet on which the image is formed by the image former, a cooler to cool the sheet dried by the dryer, and an inspection unit to inspect the image on the sheet cooled by the cooler, wherein the dryer, the cooler, and the inspection unit are arranged below the image former.

### CROSS-REFERENCE TO RELATED APPLICATIONS

This patent application is based on and claims priority pursuant to 35 U.S.C. § 119 (a) to Japanese Patent Application No. 2023-166132, filed on Sep. 27, 2023, in the Japan Patent Office, the entire disclosure of which is hereby incorporated by reference herein.

### BACKGROUND

### Technical Field

Embodiments of this disclosure relate to an image forming apparatus and an image forming system.

### Related Art

Examples of an image forming system that forms an image on a sheet include an image forming system including a dryer that dries the sheet, a cooler that cools the sheet, and the like in addition to an image former.

For example, Japanese Unexamined Patent Application Publication No. 2020-1282 discloses an image forming system in which a dryer (drying unit) and a cooler (cooling and conveying unit) are arranged beside an image former (printer).

The configuration where the units such as the dryer and the cooler are arranged beside the image former has a disadvantage in that a horizontal installation space increases.

Therefore, an object of the present embodiment is to reduce a horizontal installation space.

### SUMMARY

In an aspect of the present disclosure, an image forming apparatus includes an image former to form an image on a sheet; a dryer to dry the sheet on which the image is formed by the image former; a cooler to cool the sheet dried by the dryer; and an inspection unit to inspect the image on the sheet cooled by the cooler, wherein the dryer, the cooler, and the inspection unit are arranged below the image former.

In another aspect of the present disclosure, an image forming system includes a first image forming apparatus including: a first image former to form a first image on one surface of a sheet; a first dryer to dry the sheet on which the first image is formed by the first image former; a first cooler to cool the sheet dried by the first dryer; and a first inspection unit to inspect the first image on the sheet cooled by the first cooler, a second image forming apparatus comprising: a second image former to form a second image on another surface of the sheet having the one surface on which the first image has been formed; a second dryer to dry the sheet on which the second image is formed by the second image former; a second cooler to cool the sheet dried by the second dryer; and a second inspection unit to inspect the second image on the sheet cooled by the second cooler; and a controller configured to control the second image former of the second image forming apparatus to from the second image on said another surface of the sheet based on an inspection result of the first inspection unit of the first image forming apparatus, wherein the first dryer, the first cooler, and the first inspection unit are arranged below the first image former, and the second dryer, the second cooler, and the second inspection unit are arranged below the second image former.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a general arrangement of an image forming system according to a first embodiment of the present embodiment;

FIG. 2 is a block diagram illustrating a controller of the image forming system according to the first embodiment of the present embodiment;

FIG. 3 is a block diagram illustrating a more specific configuration of the controller according to the first embodiment of the present embodiment;

FIG. 4 is a diagram illustrating an overall operation flow of the image forming system according to the first embodiment of the present embodiment;

FIG. 5 is a schematic configuration diagram of an image forming apparatus according to the first embodiment of the present embodiment;

FIG. 6 is a schematic configuration diagram of a dryer according to the first embodiment of the present embodiment;

FIG. 7 is a diagram for describing distinctive features of the dryer according to the first embodiment of the present embodiment;

FIG. 8 is a perspective view of an air blowing unit according to the first embodiment of the present embodiment;

FIG. 9 is a diagram illustrating an air supply and exhaust flow path provided in the dryer according to the first embodiment of the present embodiment;

FIG. 10 is a diagram illustrating a direction of airflow generated in the image forming apparatus according to the first embodiment of the present embodiment;

FIG. 11 is a schematic configuration diagram of a cooler according to the first embodiment of the present embodiment;

FIGS. 12A to 12C are diagrams each illustrating an example where a guide roller is repositioned to adjust a contact distance between a sheet and a cooling drum in a conveyance direction in the first embodiment of the present embodiment;

FIG. 13 is a schematic configuration diagram of an inspection unit according to the first embodiment of the present embodiment; and

FIG. 14 is a diagram illustrating a configuration of a dryer according to a second embodiment of the present embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

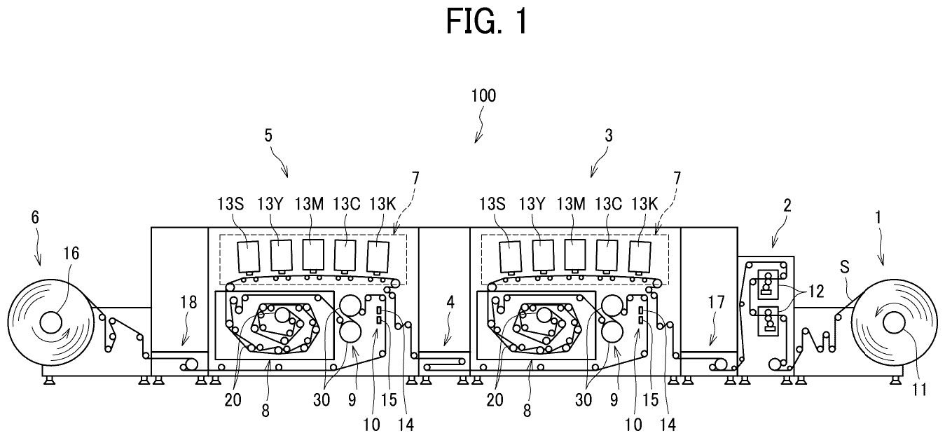

First, a general arrangement of an image forming system 100 according to a first embodiment of the present embodiment will be described with reference to FIG. 1. Referring now to the drawings for use in explaining the present embodiment, wherein like reference numerals designate identical or corresponding parts throughout the several views thereof, an image forming system according to an embodiment of the present disclosure is described below.

### Configuration of Image Forming System

As illustrated in FIG. 1, the image forming system 100 includes a sheet feeding apparatus 1, a pre-processing apparatus 2, a first tension regulating apparatus 17, a first image forming apparatus 3, a front and back reversing apparatus 4, a second image forming apparatus 5, a second tension regulating apparatus 18, and a sheet collecting apparatus 6.

The sheet feeding apparatus 1 includes a feeding roller 11 around which a long sheet S is wound into a roll shape. In response to the rotation of the feeding roller 11 in a direction of an arrow illustrated in FIG. 1, the sheet S is fed out from the feeding roller 11.

The pre-processing apparatus 2 includes a treatment liquid coater 12 that applies a treatment liquid to one side or both sides of the sheet S. The treatment liquid is, for example, a liquid with a function of aggregating ink, and is applied to the sheet S for the purpose of improving image quality such as preventing ink bleeding or aiding in ink permeation.

The first tension regulating apparatus 17 is an apparatus that transfers the sheet S from the pre-processing apparatus 2 to the first image forming apparatus 3 while regulating the tension of the sheet S. The first tension regulating apparatus 17 includes multiple rollers over which the sheet S is passed. Some of the rollers move to regulate the tension of the sheet S.

The first image forming apparatus 3 includes an image former 7, a dryer 8, a cooler 9, and an inspection unit 10.

The image former 7 includes multiple inkjet liquid discharge heads 13S, 13Y, 13M, 13C, and 13K as an example of a liquid discharger. In the example in FIG. 1, the liquid discharge head 13K for black ink, the liquid discharge head 13C for cyan ink, the liquid discharge head 13M for magenta ink, the liquid discharge head 13Y for yellow ink, and the liquid discharge head 13S for spot color ink are arranged in this order from the upstream side in the sheet conveyance direction in which the sheet S is conveyed. The spot color ink is ink other than black, cyan, magenta, and yellow, such as white or metallic, and is added as appropriate for the intended use. The arrangement of the liquid discharge heads 13S, 13Y, 13M, 13C, and 13K is not limited to the order illustrated in FIG. 1, and may be in any order.

The dryer 8 includes a heating rotator 20 that heats the sheet S. The heating rotator 20 rotates in response to the conveyance of sheet S.

The cooler 9 includes a cooling rotator 30 that cools the sheet S. As with the heating rotator 20, the cooling rotator 30 rotates in response to the conveyance of the sheet S.

The inspection unit 10 includes a scanner camera 14 that acquires position information regarding an image on the sheet S, and a colorimeter 15 that acquires color information regarding the image on the sheet S. The scanner camera 14 and the colorimeter 15 are examples of a non-contact inspection apparatus that inspects the image on the sheet S, and either the scanner camera 14 or the colorimeter 15 may be provided, or another inspection apparatus may be provided. In the example illustrated in FIG. 1, the scanner camera 14 is disposed on the upstream side of the colorimeter 15 in the sheet conveyance direction, but on the contrary, the colorimeter 15 may be disposed on the upstream side of the scanner camera 14 in the sheet conveyance direction. The scanner camera 14 and the colorimeter 15 each include a detector disposed to cover the entire width of the sheet S, so that the entire width of the sheet S can be inspected. The scanner camera 14 preferably has a resolution equal to or higher than an image resolution.

The front and back reversing apparatus 4 includes a known apparatus that reverses the positions of the front and back sides of the sheet S.

As with the first image forming apparatus 3, the second image forming apparatus 5 includes an image former 7, a dryer 8, a cooler 9, and an inspection unit 10. The image former 7, the dryer 8, the cooler 9, and the inspection unit 10 included in the second image forming apparatus 5 are basically identical in configuration to the image former 7, the dryer 8, the cooler 9, and the inspection unit 10 included in the first image forming apparatus 3, respectively, so that duplicate descriptions thereof will be omitted.

The second tension regulating apparatus 18 is an apparatus that transfers the sheet S from the second image forming apparatus 5 to the sheet collecting apparatus 6 while regulating the tension of the sheet S. The second tension regulating apparatus 18 is basically identical in configuration to the first tension regulating apparatus 17. A space that is a part of an outer cover recessed backward in FIG. 1 is provided on each of the first tension regulating apparatus 17, the front and back reversing apparatus 4, and the second tension regulating apparatus 18 so as to allow an operator to enter. This allows the operator to stand on the first tension regulating apparatus 17, the front and back reversing apparatus 4, or the second tension regulating apparatus 18 to operate a control panel or perform maintenance work.

The sheet collecting apparatus 6 includes a collecting roller 16 around which the sheet S is wound for collection. In response to the rotation of the collecting roller 16 in the direction of the arrow illustrated in FIG. 1, the sheet S is collected in a roll form.

### Configuration of Controller

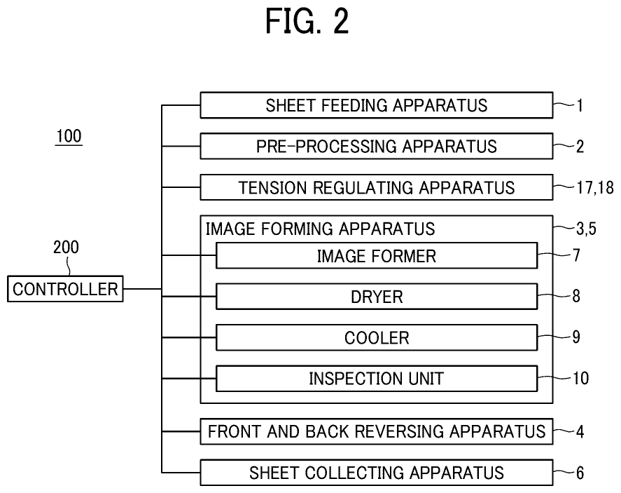

FIG. 2 is a block diagram illustrating a controller 200 of the image forming system 100 according to the first embodiment of the present embodiment.

As illustrated in FIG. 2, the image forming system 100 includes the controller 200 that controls various operations of the sheet feeding apparatus 1, the pre-processing apparatus 2, the first tension regulating apparatus 17, the first image forming apparatus 3, the front and back reversing apparatus 4, the second image forming apparatus 5, the second tension regulating apparatus 18, and the sheet collecting apparatus 6. For example, the controller 200 controls a rotational speed of the feeding roller 11, an ink discharge operation of each of the liquid discharge heads 13Y, 13M, 13C, and 13K, a heating temperature of the heating rotator 20, a cooling temperature of the cooling rotator 30, a rotational speed of the collecting roller 16, tension applied to the sheet S, and the like.

The controller 200 can also correct data on an image to be formed on the sheet S and correct image forming conditions on the basis of position information regarding an image acquired by the scanner camera 14 and color information regarding the image acquired by the colorimeter 15, the scanner camera 14 and the colorimeter 15 being included in the inspection unit 10.

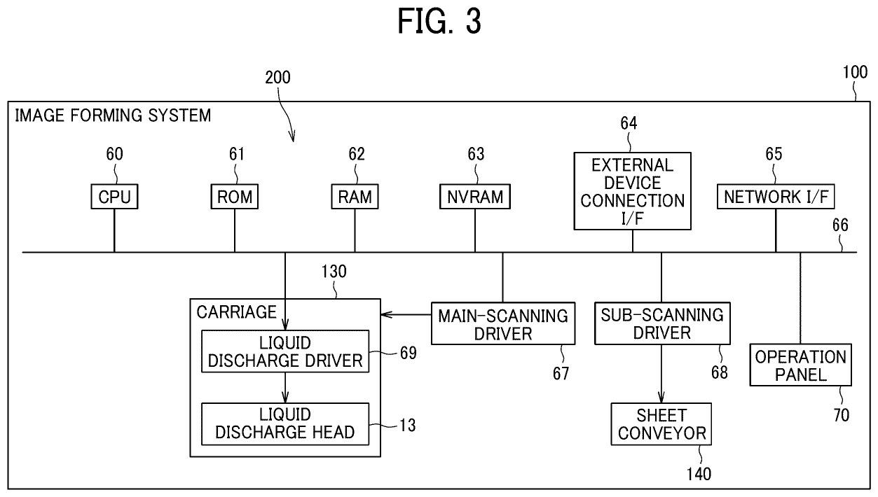

FIG. 3 is a block diagram illustrating a more specific configuration of the controller 200 according to the first embodiment of the present embodiment.

As illustrated in FIG. 3, the controller 200 includes a central processing unit (CPU) 60, a read only memory (ROM) 61, a random access memory (RAM) 62, a non-volatile random access memory (NVRAM) 63, an external device connection interface (I/F) 64, a network I/F 65, a bus line 66, a main-scanning driver 67, a sub-scanning driver 68, a liquid discharge driver 69, and an operation panel 70.

The CPU 60 controls the overall operation of the image forming system 100. The ROM 61 stores programs, such as an initial program loader (IPL), and the like used for driving the CPU 60. The RAM 62 is used as a work area of the CPU 60. The NVRAM 63 stores various data such as programs, and holds various data even while the power supply to the image forming system 100 is cut off.

The external device connection I/F 64 is connected to a personal computer (PC) over a universal serial bus (USB) cable or the like and communicates a control signal and print data with the PC. The network I/F 65 is an interface for data communication using a communication network such as the Internet. The bus line 66 includes an address bus, a data bus, and the like for electrically connecting each component such as the CPU 60.

The main-scanning driver 67 controls movement, in a main-scanning direction, of a carriage 130 in which the liquid discharge head 13 is installed. The “main-scanning direction” referred to herein means a width direction of the sheet and a direction orthogonal to the sheet conveyance direction on a plane parallel to the sheet.

The sub-scanning driver 68 controls a sheet conveyor 140 to convey the sheet S. The sheet conveyor 140 includes, for example, a roller and a motor that drives the roller, and intermittently conveys the sheet S in the sub-scanning direction that coincides with the sheet conveyance direction. While the sheet S is intermittently conveyed in the sub-scanning direction under the control of the sub-scanning driver 68, the carriage 130 moves in the main-scanning direction under the control of the main-scanning driver 67, and ink is discharged from the liquid discharge head 13, thereby forming an image on the sheet S.

The liquid discharge driver 69 controls a liquid discharge operation of the liquid discharge head 13. In this example, the liquid discharge driver 69 is installed in the carriage 130, but the liquid discharge driver 69 may be connected to the bus line 66 outside the carriage 130. The main-scanning driver 67, the sub-scanning driver 68, and the liquid discharge driver 69 may be each a function implemented by instructions executed by the CPU 60 in accordance a corresponding program.

The operation panel 70 displays a current setting value, a selection screen, and the like, and includes a touch panel that receives input from the operator, an alarm lamp, and the like.

### Overall Operation of Image Forming System

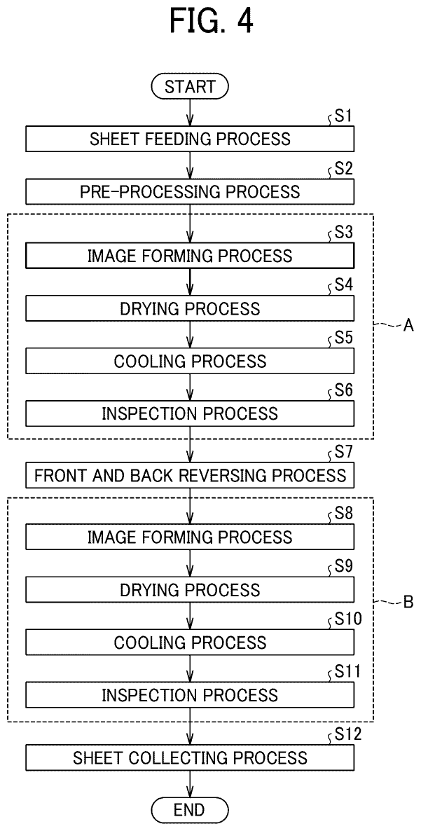

FIG. 4 is a diagram illustrating an overall operation flow of the image forming system 100 according to the first embodiment of the present embodiment.

In response to start-up of the image forming system 100, the feeding roller 11 of the sheet feeding apparatus 1 rotates to perform a “sheet feeding process” of feeding the sheet S from the feeding roller 11.

Then, the sheet S is conveyed to the pre-processing apparatus 2, and a “pre-processing process” of causing the treatment liquid coater 12 of the pre-processing apparatus 2 to apply a treatment liquid to the sheet S is performed.

Subsequently, the sheet S is conveyed to the first image forming apparatus 3 via the first tension regulating apparatus 17. Then, in the first image forming apparatus 3, an “image forming process” of forming an image on the sheet S, a “drying process” of drying the sheet S, a “cooling process” of cooling the sheet S, and an “inspection process” of inspecting the sheet S that each belong to a process A are sequentially performed. First, in the “image forming process”, the sheet S is conveyed to the image former 7 in the first image forming apparatus 3, and the liquid discharge heads 13, 13Y, 13M, 13C, and 13K each discharge corresponding ink to a first surface (front surface) of the sheet S to form an image on the first surface.

Next, the sheet S is conveyed to the dryer 8 in the first image forming apparatus 3, and the dryer 8 performs the “drying process”. In the dryer 8, the sheet S thus conveyed comes into with the surface of the heating rotator 20 to be heated. Accordingly, a liquid component of ink on the sheet S evaporates to dry the sheet S.

Subsequently, the sheet S is conveyed to the cooler 9 in the first image forming apparatus 3, and the cooler 9 performs the “cooling process”. In the cooler 9, the sheet S thus conveyed comes into contact with the surface of the cooling rotator 30 to be cooled.

The sheet S is conveyed to the inspection unit 10 in the first image forming apparatus 3, and the inspection unit 10 performs the “inspection process”. In the “inspection process”, the scanner camera 14 acquires position information regarding the image on the sheet S, and the colorimeter 15 acquires color information regarding the image on the sheet S.

Subsequently, the sheet S is conveyed to the front and back reversing apparatus 4, and the front and back reversing apparatus 4 performs a “front and back reversing process” of reversing the front and back sides of the sheet S.

The sheet S thus reversed is conveyed to the second image forming apparatus 5. That is, in the second image forming apparatus 5, the sheet S is conveyed so as to cause a second surface (back surface) of the sheet S opposite from the first surface to face each of the liquid discharge heads 13, 13Y, 13M, 13C, and 13K. In response to the conveyance of the sheet S to the second image forming apparatus 5, ink is discharged onto the second surface of the sheet S to form an image on the second surface. As with the first image forming apparatus 3, the second image forming apparatus 5 performs a “drying process”, a “cooling process”, and an “inspection process” in addition to the “image forming process”, each of the processes belonging to a process B. The “image forming process”, the “drying process”, the “cooling process”, and the “inspection process” in the second image forming apparatus 5 are each basically the same as the corresponding process A in the first image forming apparatus 3, so that duplicate descriptions thereof will be omitted.

Subsequently, a “sheet collecting process” of conveying the sheet S to the sheet collecting apparatus 6 via the second tension regulating apparatus 18 is performed. In the “sheet collecting process”, the sheet S is collected in a roll form by the collecting roller 16. This is the end of the series of operations of the image forming system 100.

As described above, in the image forming system 100 according to the first embodiment of the present embodiment, the first image forming apparatus 3 and the second image forming apparatus 5 each perform the “inspection process” of acquiring the position information and the color information regarding the image, so that a defective image can automatically detected. For example, a positional shift between a target image and an actual image on each of the first surface and the second surface of the sheet S, a relative positional shift between the images on the first surface and the second surface, a difference in image size, and the like can be detected on the basis of the position information regarding the image acquired by the scanner camera 14. Color unevenness, color loss, and the like of each of the images on the first surface and the second surface can also be detected on the basis of the color information regarding the image acquired by the colorimeter 15.

The controller 200 may feedback the results obtained from the respective “inspection processes” to the respective “image forming processes” of the first image forming apparatus 3 and the second image forming apparatus 5 and perform image formation on the basis of corrected image data or image forming conditions. Accordingly, the occurrence of image positional shift, color unevenness, and the like can be prevented. The controller 200 may perform feedforward control on the “image forming process” of the second image forming apparatus 5 on the basis of the result obtained from the “inspection process” of the first image forming apparatus 3. In this case, the positional shift of each of the images on the first surface and the second surface can be prevented, and image quality can be improved. The feedback control and the feedforward control based on the inspection results may be selected and executed in accordance with the image forming conditions or an image forming mode. In a case where a defective image occurs, a position of the defective image may be marked on the sheet S or information regarding the defective image may be recorded so as to allow the operator or the like to confirm a defective position or a defective state after collecting the sheet. Accordingly, in the first embodiment of the present embodiment, since the image forming system 100 includes the inspection unit 10 that automatically inspects an image, the image quality can be improved, and the monitoring or inspection burden on the operator can be reduced.

### Disadvantage in Image Forming System

For an image forming system including multiple apparatuses such as a sheet feeding apparatus, a pre-processing apparatus, and an image forming apparatus, in a case where the apparatuses are arranged side by side, a horizontal installation space increases to create constraints on the installation of the image forming system. In particular, in the field of commercial printing and the like, large-scale apparatuses are used, so that the disadvantage related to the installation space becomes more pronounced.

Some known configurations employ an aspect where an inspection apparatus is added as an optional unit as necessary. In this case, the inspection apparatus is generally disposed side by side with respect to peripheral apparatuses, so that the addition of the inspection apparatus causes an increase in installation space of the entire image forming system. In a case where the inspection apparatus is separate from the other apparatuses, there is a possibility that the inspection apparatus when added suffers a positional shift relative to the peripheral apparatuses, and the inspection of the image on the sheet becomes less accurate. The image inspection is preferably performed in a stable state immediately after the sheet is dried and cooled; however, in a case where the inspection apparatus is a separate apparatus, a conveyance distance of the sheet from the drying apparatus and the cooling apparatus to the inspection apparatus becomes long, which makes the image inspection difficult to perform immediately after drying and cooling.

The present embodiment therefore has a first object to reduce the horizontal installation space in the image forming system and a second object to improve the inspection accuracy. A description will be given below of distinctive features of the present embodiment with reference to the configuration according to the first embodiment of the present embodiment as an example.

### <Configuration of Distinctive Features According to First Embodiment of Present Embodiment>

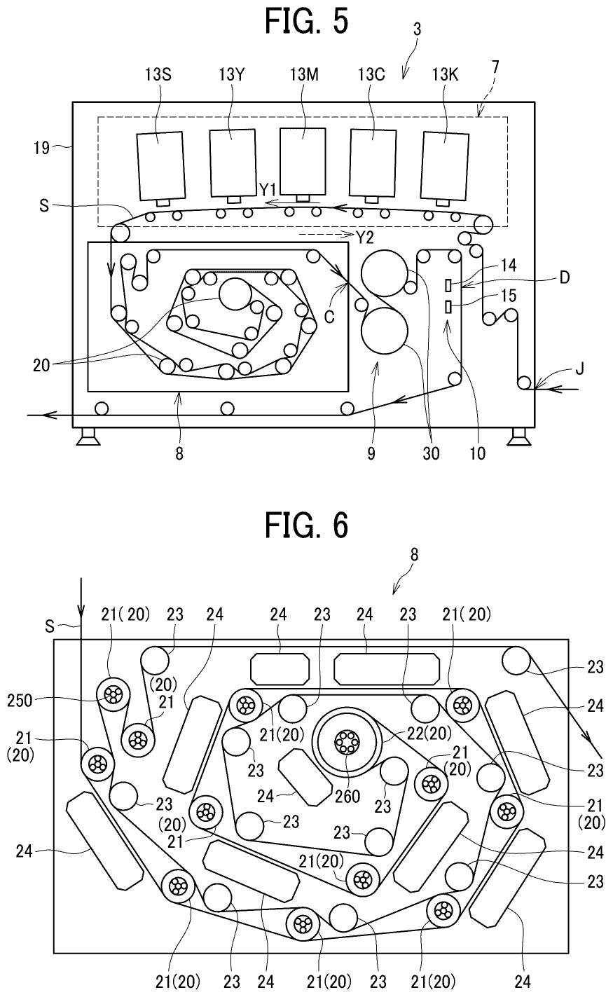

FIG. 5 is a schematic configuration diagram of the image forming apparatus 3 according to the first embodiment of the present embodiment.

First, the layout of the image former 7, the dryer 8, the cooler 9, and the inspection unit 10 will be described with reference to FIG. 5. The configuration of the first image forming apparatus 3 will be described below as an example, and the second image forming apparatus 5 is identical in configuration to the first image forming apparatus 3, so that duplicate descriptions thereof will be omitted.

As illustrated in FIG. 5, in the first image forming apparatus 3, the dryer 8, the cooler 9, and the inspection unit 10 are arranged below the image former 7. The “below” the image former 7 referred to herein means that the dryer 8, the cooler 9, and the inspection unit 10 are arranged below the image former 7 so as to cause the dryer 8, the cooler 9, and the inspection unit 10 to at least partially coincide with the image former 7 when viewed from above in the vertical direction. Therefore, when viewed from above in the vertical direction, the dryer 8, the cooler 9, and the inspection unit 10 are arranged so as to entirely coincide with the image former 7, or alternatively, the dryer 8, the cooler 9, and the inspection unit 10 may be arranged so as to partially coincide with the image former 7.

In the first embodiment of the present embodiment, most of the dryer 8, the whole of the cooler 9, and the whole of the inspection unit 10 are arranged below the image former 7. In a case where a direction in which the sheet S is conveyed in the image former 7 is defined as a first direction Y1, and a direction opposite to the first direction Y1 is defined as a second direction Y2, the dryer 8, the cooler 9, and the inspection unit 10 are arranged in order of the dryer 8, the cooler 9, and the inspection unit 10 in the second direction Y2. Therefore, in the first embodiment of the present embodiment, an outlet C of the dryer 8 and an inlet D of the inspection unit 10 are arranged below the image former 7. In this case, the “outlet C of the dryer 8” corresponds to, for example, a portion where the sheet S is ejected from a housing of the dryer 8, and includes a transfer portion or a connection portion where the sheet S is transferred from the dryer 8 to the cooler 9. The “inlet D of the inspection unit 10” corresponds to, for example, a portion where the sheet S enters an inspection range (detection range) of the scanner camera 14, and includes a transfer portion or a connection portion where the sheet S is transferred from the cooler 9 to the inspection unit 10. An inlet J of the image forming apparatus is disposed below the outlet C of the dryer 8 and the whole of the cooler 9. The “inlet J of the image forming apparatus” referred to herein corresponds to a connection portion or transfer portion between the image forming apparatus and the closest apparatus located on the upstream side of the image forming apparatus in the sheet conveyance direction. For example, for the first image forming apparatus 3, a connection portion or transfer portion between the first image forming apparatus 3 and the first tension regulating apparatus 17 corresponds to the inlet of the first image forming apparatus 3, and for the second image forming apparatus 5, a connection portion or transfer portion between the second image forming apparatus 5 and the front and back reversing apparatus 4 corresponds to the inlet of the second image forming apparatus 5. “Below the outlet C of the dryer 8 and the whole of the cooler 9” means a position lower than the outlet C of the dryer 8 and the whole of the cooler 9 in the vertical direction.

Accordingly, in the first embodiment of the present embodiment, since the dryer 8, the cooler 9, and the inspection unit 10 are arranged below the image former 7, the horizontal installation space can be reduced as compared with a configuration where the dryer 8, the cooler 9, and the inspection unit 10 are arranged side by side with respect to the image former 7 in the horizontal direction. According to the first embodiment of the present embodiment, the image forming system becomes less constrained by the installation area, which allows the image forming system to be easily installed and allows another apparatus to be easily added as necessary.

In the first embodiment of the present embodiment, since the dryer 8, the cooler 9, and the inspection unit 10 are arranged in order of the dryer 8, the cooler 9, and the inspection unit 10 in the second direction Y2, a conveyance path through which the sheet S is sequentially and efficiently conveyed from the image former 7 to the dryer 8, the cooler 9, and the inspection unit 10 is formed. That is, since the sheet S is first conveyed in the image former 7 in the first direction Y1 and is then conveyed, like a U-turn, from the dryer 8 toward the cooler 9 and the inspection unit 10 in the second direction Y2, the conveyance path of the sheet S does not become unnecessarily long, and the sheet S can be efficiently conveyed.

The sheet S subjected to the inspection is conveyed out after passing through below the inspection unit 10, the cooler 9, and the dryer 8 in this order in the first direction Y1. Accordingly, in the first embodiment of the present embodiment, since the layout of the image former 7, the dryer 8, the cooler 9, and the inspection unit 10 is determined so as to allow the sheet S to be efficiently conveyed in the first image forming apparatus 3, the apparatus can be downsized. The conveyance distance of the sheet S conveyed from the dryer 8 and the cooler 9 to the inspection unit 10 can also be reduced, so that the image inspection can be performed in a stable state immediately after the sheet S is dried and cooled, and the inspection accuracy improves accordingly.

The dryer 8, the cooler 9, and the inspection unit 10 may be arranged in order of the dryer 8, the cooler 9, and the inspection unit 10 in the first direction Y1, which is opposite to the direction in the first embodiment of the present embodiment, on the basis of the layout of the peripheral apparatuses including the image former 7. The arrangement of the dryer 8, the cooler 9, and the inspection unit 10 can be changed as appropriate.

In the first embodiment of the present embodiment, the dryer 8, the cooler 9, and the inspection unit 10 are arranged below the image former 7, and the image former 7, the dryer 8, the cooler 9, and the inspection unit 10 are arranged in the same housing 19 included in the first image forming apparatus 3. The housing 19 accommodates the image former 7, the dryer 8, the cooler 9, and the inspection unit 10.

As compared with a configuration where the image former 7, the dryer 8, the cooler 9, and the inspection unit 10 each have its own housing, and the housings are arranged with their respective outer surfaces facing each other, the apparatus can be downsized. That is, since the image former 7, the dryer 8, the cooler 9, and the inspection unit 10 are arranged in the same housing 19, the apparatuses and the members can be arranged close to each other, so that the apparatuses and the members can be efficiently arranged and downsized. The “same housing” is not limited to a configuration where the housing includes a single outer cover member, and may have a configuration where the housing includes multiple outer cover members. The components arranged in the same housing need not necessarily be held by the same (single) side plate. That is, the present embodiment also includes a configuration where the components are held by multiple side plates.

In the first embodiment of the present embodiment, the inspection unit 10 is not a separate unit having its own housing separate from the image former 7, the dryer 8, and the cooler 9, but an integrated unit provided in the same housing 19, so that the inspection accuracy of the inspection unit 10 improves. That is, since the inspection unit 10 is provided integrally with the image former 7, the dryer 8, and the cooler 9, the relative position of the inspection unit 10 relative to the image former 7, the dryer 8, and the cooler 9 is fixed, so that the inspection unit 10 can be prevented from suffering a positional shift, and the image on the sheet S can be accurately inspected. In addition, since the conveyance distance of the sheet S conveyed from the dryer 8 and the cooler 9 to the inspection unit 10 can be reduced, the image inspection can be performed in a stable state immediately after the sheet S is dried and cooled, and the inspection accuracy improves accordingly. This in turns improves reliability of the image inspection.

Accordingly, the first embodiment of the present embodiment allows a reduction in the horizontal installation space and leads to an improvement in the inspection accuracy. On the other hand, since the dryer 8, the cooler 9, and the inspection unit 10 are arranged below the image former 7, there is a concern that the first image forming apparatus 3 may become large in size in the vertical direction. The increase in size in the vertical direction leads to deterioration in handleability at the time of storage and transportation of the image forming apparatus and deterioration in ease of assembly and maintainability, so that the increase in size in the vertical direction is preferably suppressed.

Therefore, in the first embodiment of the present embodiment, in order to suppress an increase in size of the image forming apparatus in the vertical direction, the following measures are taken. A detailed description will be given below of each configuration of the dryer 8, the cooler 9, and the inspection unit 10 according to the first embodiment of the present embodiment including the measures taken to suppress an increase in size in the vertical direction.

### Configuration of Dryer

FIG. 6 is a schematic configuration diagram of the dryer 8 according to the first embodiment of the present embodiment.

As illustrated in FIG. 6, the dryer 8 includes a heating roller 21, a heating drum 22, a guide roller 23, and an air blowing unit 24.

The heating roller 21 and the heating drum 22 correspond to the heating rotator 20 including heating sources 250 and 260 such as a halogen heater provided therein. The heating drum 22 corresponds to the heating rotator 20 larger in diameter than the heating roller 21, and there is one heating drum 22 disposed around the center of dryer 8. The heating roller 21 includes multiple heating rollers 21 arranged in a spiral shape around the heating drum 22.

Unlike the heating roller 21 and the heating drum 22, the guide roller 23 corresponds to a rotator that includes no heating source therein and functions as a guide member that guides the sheet S. In this case, as with the heating roller 21, the guide roller 23 includes multiple guide rollers 23 arranged in a spiral shape around the heating drum 22.

The air blowing unit 24 is a blower means that blows air to the sheet S to dry the sheet S quickly. The air blowing unit 24 includes multiple air blowing units 24 arranged so as to face the sheet S tensioned by the heating roller 21, the heating drum 22, and the guide roller 23.

When the sheet S is conveyed into the dryer 8, the sheet S is first passed over the outside of the plurality of heating rollers 21. The “outside” of the heating roller 21 referred to herein means a side of the outer peripheral surface of the heating roller 21 remote from the heating drum 22. Then, the sheet S is conveyed while being in contact with the outside of the heating roller 21, and is then wound around the heating drum 22. Subsequently, the sheet S is passed from the heating drum 22 to the guide roller 23, and is conveyed while being in contact with the inside of the plurality of heating rollers 21 (the side adjacent to the heating drum 22). Accordingly, the sheet S is conveyed such that the surface on the opposite side from the image forming surface sequentially comes into contact with the outside of the heating roller 21, the heating drum 22, and the inside of the heating roller 21 to be heated. The plurality of air blowing units 24 blows air to the image forming surface of the sheet S. Accordingly, the sheet S is dried. Subsequently, the sheet S is guided by the guide roller 23 and conveyed out from the dryer 8.

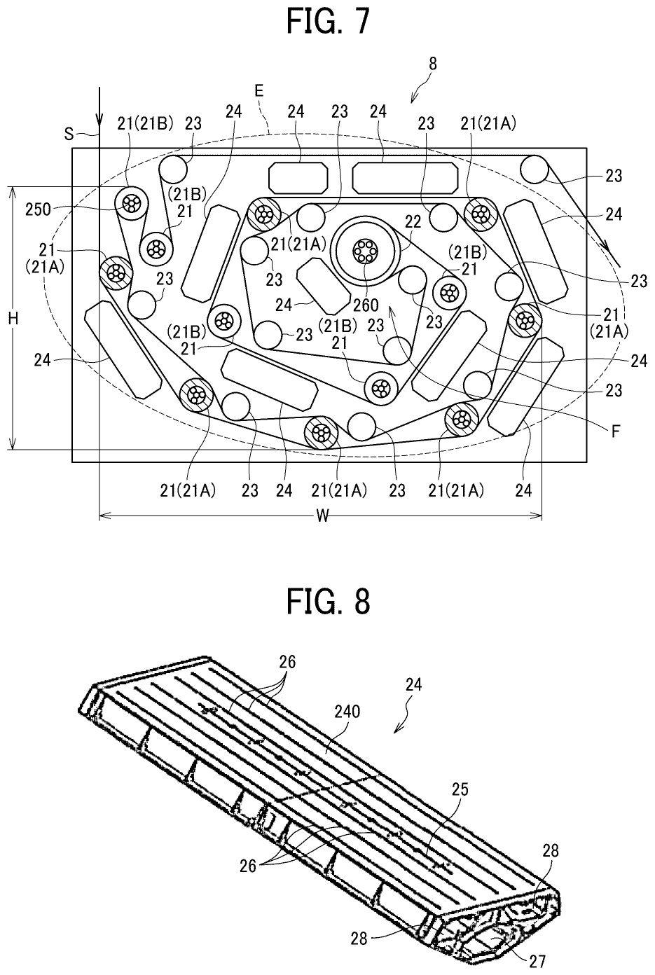

Here, as illustrated in FIG. 7, in the first embodiment of the present embodiment, the plurality of heating rollers 21 is arranged in an elliptical trajectory E. Arranging the plurality of heating rollers 21 in the elliptical trajectory E as described above allows a reduction in dimension (height) of the dryer 8 in the vertical direction. That is, arranging the plurality of heating rollers 21 in the elliptical trajectory E can make the maximum dimension H in the vertical direction of a region where each heating roller 21 is disposed smaller than the maximum dimension W in the horizontal direction when viewed from the axial direction of each heating roller 21, so that the dryer 8 can be downsized in the vertical direction. Accordingly, the first image forming apparatus 3 including the dryer 8 can be entirely downsized in the vertical direction.

In the first embodiment of the present embodiment, after the sheet S is guided in a spiral shape (counterclockwise in FIG. 7) by the plurality of heating rollers 21, the direction of the sheet S is changed with the heating drum 22 as a starting point, and the sheet S is guided in the opposite direction in a spiral shape (clockwise in FIG. 7) by the plurality of guide rollers 23. Accordingly, the sheet S is changed in direction and conveyed in the dryer 8, so that the sheet S can be efficiently heated even in a small space, and high drying performance can be achieved.

In order to implement such a compact conveyance path of the sheet S, in the first embodiment of the present embodiment, a direction changing section F for the sheet S is provided as follows.

Here, the heating rotator 20 including each heating roller 21 and the heating drum 22 includes a first heating rotator with which the sheet S comes into contact twice from different directions and a second heating rotator with which the sheet S comes into contact once. In this case, the first heating rotator corresponds to a heating roller 21A (heating roller 21A with hatching in FIG. 7) with which the sheet S comes into contact twice, and the second heating rotator corresponds to a heating roller 21B (heating roller 21B without hatching in FIG. 7) with which the sheet S comes into contact once, and the heating drum 22. After being conveyed while being in contact with the multiple heating rollers 21A (with hatching) corresponding to the first heating rotator, the sheet S is changed in direction via three heating rollers 21B (without hatching) and one heating drum 22 corresponding to the second heating rotator, and is conveyed while being in contact again with each heating rollers 21A (with hatching) corresponding to the first heating rotator.

Accordingly, in the first embodiment of the present embodiment, the three heating rollers 21B (without hatching) and the one heating drum 22 corresponding to the second heating rotator form the direction changing section F for bringing one surface of the sheet S into contact again with each heating roller 21A (with hatching) corresponding to the first heating rotator. Accordingly, a compact sheet conveyance path is implemented while ensuring high drying performance, and the apparatus is reduced in size.

FIG. 8 is a perspective view of the air blowing unit 24 according to the first embodiment of the present embodiment.

As illustrated in FIG. 8, the air blowing unit 24 has an air blowing hole 25 and an air intake hole 26 in a surface 240 located to face the sheet. The air blowing unit 24 has an air blowing duct 27 and an air intake duct 28. The air blowing duct 27 communicates with the air blowing hole 25, and the air intake duct 28 communicates with the air intake hole 26.

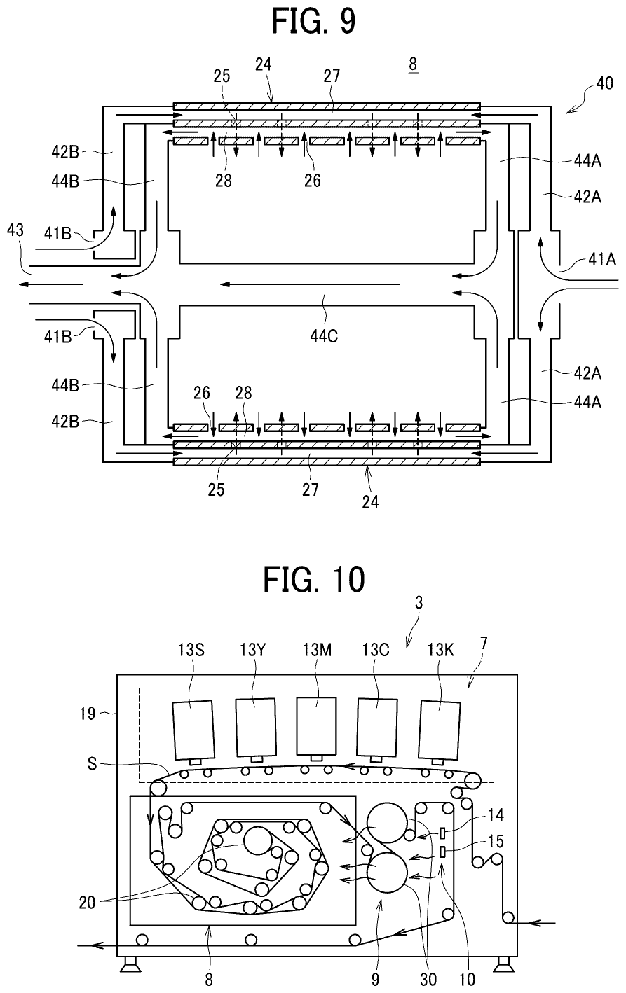

FIG. 9 is a diagram illustrating an air supply and exhaust flow path 40 provided in the dryer 8 according to the first embodiment of the present embodiment.

As illustrated in FIG. 9, the dryer 8 is provided with the air supply and exhaust flow path 40 through which air taken in from both the front side that is the right side of the drawing and the back side that is the left side of the drawing is supplied to the inside and is discharged from the back side. Specifically, the air supply and exhaust flow path 40 has air supply holes 41A and 41B provided on the front side and the back side, air supply ducts 42A and 42B communicating with the air supply holes 41A and 41B, respectively, an air exhaust hole 43 provided on the back side, and air exhaust ducts 44A, 44B, and 44C communicating with the air exhaust hole 43.

The air supply ducts 42A and 42B extend radially from the air supply holes 41A and 41B on the front side and the back side, respectively, to connect to both ends of the air blowing duct 27 of each air blowing unit 24.

Accordingly, an air supply path through which air passes from the air supply holes 41A and 41B to each air blowing unit 24 via the air supply ducts 42A and 42B is formed.

The air exhaust ducts 44A, 44B, and 44C include a front-side air exhaust duct 44A extending radially on the front side, a back-side air exhaust duct 44B extending radially on the back side, and a central air exhaust duct 44C passing through the center in the dryer 8. The front-side air exhaust duct 44A and the back-side air exhaust duct 44B are connected to both the ends of the air blowing duct 27 of each air blowing unit 24. The front-side air exhaust duct 44A and the back-side air exhaust duct 44B each communicate with the air exhaust hole 43 via the central air exhaust duct 44C. Accordingly, an air exhaust path through which air passes from each air blowing unit 24 to the air exhaust hole 43 via the air exhaust ducts 44A, 44B, and 44C is formed.

As indicated by arrows in FIG. 9, when air is taken in from the front-side air supply hole 41A and the back-side air supply hole 41B, air passes through the front-side air supply duct 42A and the back-side air supply duct 42B to the air blowing duct 27 of each air blowing unit 24. Then, the air is blown out from the air blowing hole 25 to the sheet. Accordingly, the sheet is dried quickly.

Air containing water vapor or the like generated from the sheet during drying is taken in from the air intake hole 26 of each air blowing unit 24. Then, the air taken in from the air intake hole 26 passes through the air intake duct 28 of each air blowing unit 24 and the front-side air exhaust duct 44A and the back-side air exhaust duct 44B to gather in the central air exhaust duct 44C, and is discharged from the air exhaust hole 43. Accordingly, air containing water vapor or the like is discharged from the dryer 8 to the outside, so that the humidity environment in the dryer 8 can be appropriately maintained.

Accordingly, in the first embodiment of the present embodiment, the air supply and exhaust flow path 40 through which air is supplied into the dryer 8 and is discharged from the dryer 8 is provided, so that the air supplied and discharged by the dryer 8 generates airflow from the cooler 9 and the inspection unit 10 toward the dryer 8 as indicated by arrows in FIG. 10. In the cooler 9 and the inspection unit 10, although not as much as the dryer 8, water vapor or the like may be generated from the sheet S, so that generating airflow from the cooler 9 and the inspection unit 10 toward the dryer 8 allows the water vapor or the like to move to the dryer 8.

Accordingly, the humidity environment in the cooler 9 and the inspection unit 10 can also be appropriately maintained.

The airflow can also move dust or the like floating around the inspection unit 10 toward the dryer 8, so that dust or the like can be prevented from adhering to the detector including the scanner camera 14 and the colorimeter 15, and the inspection accuracy can be maintained high enough.

### Configuration of Cooler

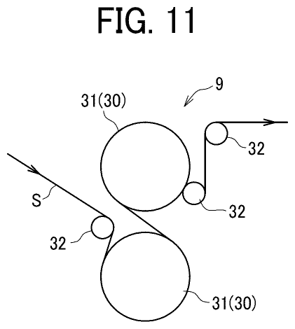

FIG. 11 is a schematic configuration diagram of the cooler 9 according to the first embodiment of the present embodiment.

As illustrated in FIG. 11, the cooler 9 includes a cooling drum 31 and a guide roller 32.

The cooling drum 31 is an example of the cooling rotator 30. The cooling drum 31 includes a rotator larger in diameter than the guide roller 32, and has a refrigerant flow path through which a refrigerant such as cooling water passes.

In this case, two cooling drums 31 are arranged in the vertical direction. The number and arrangement of the cooling drums 31 are not limited to the example illustrated in FIG. 11.

The guide roller 32 is an example of the guide member that guides the sheet S. In this case, although the guide roller 32 includes multiple guide rollers 32 arranged around the cooling drum 31, the number of guide rollers 32 may be one. The sheet S is cooled by being guided by the guide roller 32 and wound around the outer peripheral surface of each cooling drum 31.

The cooling efficiency of the sheet S varies in a manner that depends on the thickness or the type of the sheet S. For example, thick paper or the like thicker than plain paper is lower in cooling efficiency than plain paper, and thus tends to require a longer cooling time. Therefore, in the first embodiment of the present embodiment, the guide roller 32 is repositionable to allow a contact distance (winding length) in the conveyance direction between the sheet S and the cooling drum 31 to be adjusted.

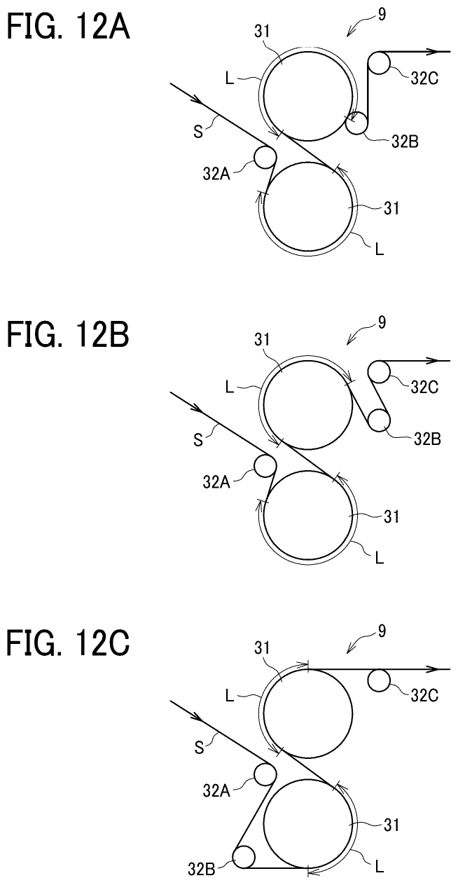

For example, repositioning a guide roller 32B from a state illustrated in FIG. 12A to a state illustrated in FIG. 12B allows a reduction in contact distance L in the conveyance direction between the sheet S and an upper cooling drum 31. In a case where the guide roller 32B is repositioned from the position in FIG. 12A the position in FIG. 12C, the contact distance L in the conveyance direction between the sheet S and both the upper and lower cooling drums 31 can be reduced.

Accordingly, in the first embodiment of the present embodiment, the contact distance L in the conveyance direction between the sheet S and the cooling drum 31 can be adjusted by repositioning the guide roller 32. Accordingly, for a sheet S that is difficult to cool, the contact distance L in the conveyance direction between the sheet S and the cooling drum 31 is increased to make the cooling time longer. On the other hand, for a sheet S that is easy to cool, the contact distance L in the conveyance direction between the sheet S and the cooling drum 31 is reduced to make the cooling time shorter, so that cooling is performed according to the thickness or the type of the sheet S.

The contact distance L in the conveyance direction of the sheet S can be adjusted in a small space, so that the apparatus can also be downsized. In the first embodiment of the present embodiment, since the cooler 9 is disposed in the housing 19 (see FIG. 10) of the first image forming apparatus 3, and does not include its own housing, the degree of freedom of repositioning of the guide roller 32 increases. That is, the guide roller 32 can be repositioned in a wide range without being restricted by the size of its own housing. Accordingly, cooling capacity can be optimized.

The repositioning of the guide roller 32 is not limited to a case where the repositioning is performed on the basis of information regarding either the type or the thickness of the sheet S, and may be performed on the basis of information regarding both the type and the thickness. The repositioning of the guide roller 32 may be manually performed by the operator or the like, or may be automatically performed by using a known moving mechanism including an eccentric cam, a spring, and the like. The contact distance L in the conveyance direction between the sheet S and the cooling drum 31 can be adjusted not only by repositioning the guide roller 32, but also by changing the number of the guide rollers 32.

### Configuration of Inspection Unit

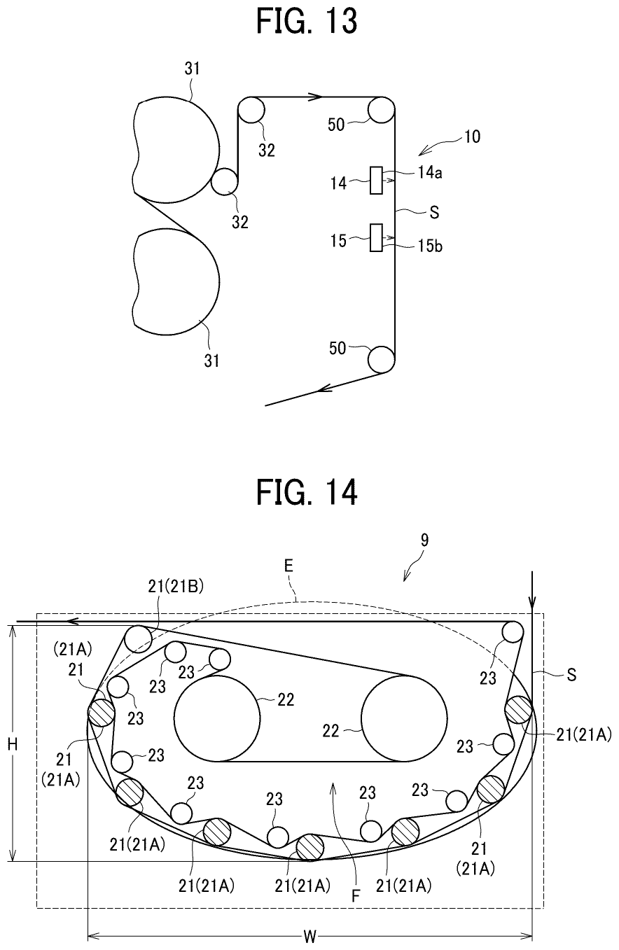

FIG. 13 is a schematic configuration diagram of the inspection unit 10 according to the first embodiment of the present embodiment.

As illustrated in FIG. 13, the inspection unit 10 includes multiple guide rollers 50 in addition to the scanner camera 14 and the colorimeter 15.

The guide rollers 50 are each an example of the guide member that guides the sheet S, and are arranged one by one above the scanner camera 14 and below the colorimeter 15. The sheet S is therefore guided from an upper guide roller 50 to a lower guide roller 50 so as to pass in front of the scanner camera 14 and the colorimeter 15. At this time, the scanner camera 14 and the colorimeter 15 are arranged so as to cause their respective detection surfaces 14a and 15a facing the image forming surface of the sheet S to face approximately horizontally in order to inspect the image on the sheet S guided downward.

Accordingly, in the first embodiment of the present embodiment, since the scanner camera 14 and the colorimeter 15 are arranged so as to cause the detection surfaces 14a and 15a to face approximately horizontally, water vapor, dust, or the like hardly adheres to the detection surfaces 14a and 15a. Accordingly, variations in detection accuracy or a decrease in detection accuracy due to adhesion of water vapor to each of the detection surfaces 14a and 15a can be avoided, and the inspection accuracy improves. In the first embodiment of the present embodiment, since the scanner camera 14 and the colorimeter 15 are arranged so as not to overlap a range above each cooling drum 31 in the vertical direction, water vapor or the like generated in the cooler 9 can be prevented from adhering to each of the detection surfaces 14a and 15a.

### Configuration of Second Embodiment of Present Embodiment

FIG. 14 is a diagram illustrating a configuration of a dryer 8 according to a second embodiment of the present embodiment.

A dryer included in an image forming apparatus according to the present embodiment may be not only the dryer 8 illustrated in FIGS. 6 and 7, but also the dryer 8 illustrated in FIG. 14. The dryer 8 illustrated in FIG. 14 includes two heating drums 22, the multiple heating rollers 21, and the multiple guide rollers 23.

In this case, the heating rollers 21 and the guide rollers 50 are arranged around the heating drums 22 not in a spiral shape but along an elliptical trajectory E. Accordingly, even in a case where the heating rollers 21 are arranged along the elliptical trajectory E, the maximum dimension H in the vertical direction of the region where the heating rollers 21 are arranged can be made smaller than the maximum dimension W in the horizontal direction of the region, so that the dryer 8 can be downsized in the vertical direction.

In the example illustrated in FIG. 14, when the sheet S is conveyed into the dryer 8, the sheet S is conveyed while being in contact with the multiple heating rollers 21A (with hatching) corresponding to the first heating rotator. Then the sheet S is changed in direction via one heating roller 21B (without hatching) and two heating drums 22 corresponding to the second heating rotator, and the sheet S is conveyed while being guided by the multiple guide rollers 23 so as to come into contact again with each of the heating rollers 21A (with hatching) corresponding to the first heating rotator.

In this case, the one heating roller 21B (without hatching) and the two heating drums 22 with which the sheet S comes into contact once function as the second heating rotator that changes the direction of the sheet S and brings one surface of the sheet S into contact again with each of the heating rollers 21A (with hatching) corresponding to the first heating rotator. That is, in this case, the three second heating rotators including the one heating roller 21B and the two heating drums 22 form a direction changing section F for changing the direction of the sheet S. Accordingly, a compact sheet conveyance path can be implemented while ensuring high drying performance with the direction changing section F formed by the three second heating rotators. The number of the second heating rotators arranged in the path through which the sheet having one surface in contact with and passing through the first heating rotators is guided so as to bring the one surface of the sheet into contact again with the first heating rotators, that is, the number of the second heating rotators forming the direction changing section F may be three or four as in the example illustrated in FIG. 7, or may be five or more.

Although the embodiments of the image forming system and the image forming apparatus according to the present embodiment have been described above, the image forming system and the image forming apparatus according to the present embodiment are not limited to the above-described embodiments. The image forming system and the image forming apparatus according to the present embodiment are not limited to a configuration where a significant image such as characters or figures is visualized by discharged liquid, and may have a configuration where a pattern or the like that has no specific meaning is formed. The image referred to in the present embodiment is not limited to characters, line drawings, pictures, and the like, and includes a circuit pattern formed on a printed wiring board, a symbol diagram, and the like.

The image forming system according to the present embodiment may include a post-processing apparatus that winds, for collection, a long continuous sheet subjected to image formation and cuts the sheet subjected to image formation. The image forming system according to the present embodiment may form an image on a sheet cut into a predetermined size in advance.

The liquid discharger included in the image forming apparatus according to the present embodiment may discharge liquid while moving, or may discharge liquid without moving. Specific examples include a serial-type liquid discharge head that discharges liquid while moving in the sheet width direction relative to a stationary sheet, and a line-type liquid discharge head that discharges liquid in a stationary state relative to a moving sheet.

The liquid to be discharged by the liquid discharger is not particularly limited and may be any liquid as long as the liquid has dischargeable viscosity or surface tension; however, the viscosity of the liquid is preferably 30 mPa·s or less under normal temperature and normal pressure or is preferably adjusted to 30 mPa·s or less by heating or cooling. More specifically, examples of the liquid include a solution, a suspension, and an emulsion that contain, for example, a solvent, such as water or an organic solvent, a colorant, such as dye or pigment, a functional material, such as a polymerizable compound, a resin, or a surfactant, a biocompatible material, such as deoxyribonucleic acid (DNA), amino acid, protein, or calcium, or an edible material, such as a natural colorant.

The sheet used in the present embodiment includes: a sheet to which a liquid can at least temporarily adhere; a sheet to which a liquid can securely adhere; and a sheet which a liquid can adhere to and permeate. Specific examples of the sheet include recording media, such as paper, recording paper, recording paper, a film, and cloth, and electronic substrates. Examples of the material of the sheet include paper, thread, fiber, cloth, leather, metal, plastic, glass, wood, and ceramics. The sheet may be conveyed continuously without interruption from the sheet feeding apparatus to the sheet collecting apparatus, or may be conveyed not continuously but one by one from the sheet feeding apparatus to the sheet collecting apparatus.

To summarize the aspects of the present embodiment described above, the present embodiment includes at least the following aspects.

### Aspect 1

According to Aspect 1, an image forming apparatus includes an image former that forms an image on a sheet, a dryer that dries the sheet, a cooler that cools the sheet, and an inspection unit that inspects the sheet, and the dryer, the cooler, and the inspection unit are arranged below the image former.

### Aspect 2

According to Aspect 2, in the image forming apparatus of Aspect 1, the dryer, the cooler, and the inspection unit are each disposed so as to at least partially coincide with a part of the image former when viewed from above in a vertical direction.

### Aspect 3

According to Aspect 3, in the image forming apparatus of Aspect 1 or 2, the image former, the dryer, the cooler, and the inspection unit are provided in the same housing.

### Aspect 4

According to Aspect 4, in the image forming apparatus of any one of Aspects 1 to 3, an outlet of the dryer, the whole of the cooler, and an inlet of the inspection unit are arranged below the image former.

### Aspect 5

According to Aspect 5, in the image forming apparatus of any one of Aspects 1 to 4, an inlet of the image forming apparatus is disposed below an outlet of the dryer and the whole of the cooler.

### Aspect 6

According to Aspect 6, in the image forming apparatus of any one of Aspects 1 to 5, in a case where a direction in which the sheet is conveyed through the image former is defined as a first direction, and a direction opposite to the first direction is defined as a second direction, the dryer, the cooler, and the inspection unit are arranged in order of the dryer, the cooler, and the inspection unit in the second direction.

### Aspect 5

According to Aspect 7, in the image forming apparatus of any one of Aspects 1 to 6, the dryer includes multiple first heating rotators with which the sheet comes into contact twice from different directions, and a second heating rotator with which the sheet comes into contact once, and at least three of the second heating rotators are arranged in a path through which the sheet having one surface in contact with and passing through the first heating rotators is guided so as to bring the one surface of the sheet into contact with the first heating rotators.

### Aspect 8

According to Aspect 8, in the image forming apparatus of any one of Aspects 1 to 7, airflow directed from the inspection unit and the cooler toward the dryer is generated.

### Aspect 9

According to Aspect 9, in the image forming apparatus of any one of Aspects 1 to 8, the cooler includes a cooling rotator that cools the sheet, and a guide member that guides the sheet.

### Aspect 10

According to Aspect 10, in the image forming apparatus of Aspect 9, the guide member is repositioned to vary a contact distance between the sheet and the cooling rotator.

### Aspect 11

According to Aspect 11, in the image forming apparatus of Aspect 10, the guide member is repositioned on the basis of at least either a type or a thickness of the sheet.

### Aspect 12

According to Aspect 12, an image forming system includes an image forming apparatus according to any one of Aspects 1 to 11, and a controller that controls the image forming apparatus.

### Aspect 13

According to Aspect 12, an image forming system includes: a first image forming apparatus including: a first image former to form a first image on one surface of a sheet; a first dryer to dry the sheet on which the first image is formed by the first image former; a first cooler to cool the sheet dried by the first dryer; and a first inspection unit to inspect the first image on the sheet cooled by the first cooler, a second image forming apparatus including: a second image former to form a second image on another surface of the sheet having the one surface on which the first image has been formed; a second dryer to dry the sheet on which the second image is formed by the second image former; a second cooler to cool the sheet dried by the second dryer; and a second inspection unit to inspect the second image on the sheet cooled by the second cooler; and a controller configured to control the second image former of the second image forming apparatus to from the second image on said another surface of the sheet based on an inspection result of the first inspection unit of the first image forming apparatus, wherein the first dryer, the first cooler, and the first inspection unit are arranged below the first image former, and the second dryer, the second cooler, and the second inspection unit are arranged below the second image former.

Any one of the above-described operations may be performed in various other ways, for example, in an order different from the one described above.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements such as the controller 200 disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An image forming apparatus comprising:
an image former to form an image on a sheet;
a dryer to dry the sheet on which the image is formed by the image former;
a cooler to cool the sheet dried by the dryer; and
an inspection unit to inspect the image on the sheet cooled by the cooler,
wherein the dryer, the cooler, and the inspection unit are arranged below the image former.

2. The image forming apparatus according to claim 1,
wherein each of the dryer, the cooler, and the inspection unit partially coincide with a part of the image former in a vertical direction.

3. The image forming apparatus according to claim 1, further comprising a housing accommodating the image former, the dryer, the cooler, and the inspection unit.

4. The image forming apparatus according to claim 1,
wherein an outlet of the dryer, a whole of the cooler, and an inlet of the inspection unit are arranged below the image former.

5. The image forming apparatus according to claim 1, further comprising an inlet disposed below an outlet of the dryer and a whole of the cooler.

6. The image forming apparatus according to claim 1, further comprising a conveyor to:
convey the sheet through the image former in a first direction; and
convey the sheet through the dryer, the cooler, and the inspection unit in a second direction opposite to the first direction,
wherein the dryer, the cooler, and the inspection unit are arranged in an order of the dryer, the cooler, and the inspection unit in the second direction.

7. The image forming apparatus according to claim 1,
wherein the dryer includes:
multiple first heating rotators contacting with the sheet twice from different directions;
three or more second heating rotators contacting with the sheet once, and
the three or more second heating rotators guide the sheet to bring one surface of the sheet that has been in contact with and passed through the first heating rotators, again, into contact with the first heating rotators. and

8. The image forming apparatus according to claim 1,
wherein the inspection unit and the cooler generate airflow directed toward the dryer.

9. The image forming apparatus according to claim 1,
wherein the cooler includes:
a cooling rotator to cool the sheet; and
a guide member to guide the sheet.

10. The image forming apparatus according to claim 9, further comprising circuitry configured to reposition the guide member to vary a contact distance between the sheet and the cooling rotator.

11. The image forming apparatus according to claim 10, further comprising circuitry configured to reposition the guide member based on at least one of type or a thickness of the sheet.

12. An image forming system comprising:
the image forming apparatus according to claim 1; and
circuitry configured to control the image forming apparatus.

13. An image forming system comprising:
a first image forming apparatus comprising:
a first image former to form a first image on one surface of a sheet;
a first dryer to dry the sheet on which the first image is formed by the first image former;
a first cooler to cool the sheet dried by the first dryer; and
a first inspection unit to inspect the first image on the sheet cooled by the first cooler,
a second image forming apparatus comprising:
a second image former to form a second image on another surface of the sheet having the one surface on which the first image has been formed;
a second dryer to dry the sheet on which the second image is formed by the second image former;
a second cooler to cool the sheet dried by the second dryer; and
a second inspection unit to inspect the second image on the sheet cooled by the second cooler; and
circuitry configured to control the second image former of the second image forming apparatus to from the second image on said another surface of the sheet based on an inspection result of the first inspection unit of the first image forming apparatus,
wherein the first dryer, the first cooler, and the first inspection unit are arranged below the first image former, and
the second dryer, the second cooler, and the second inspection unit are arranged below the second image former.
